(19) United States
(12) Patent Application Publication
(10) Pub. No.: US 2024/0262232 A1
(43) Pub. Date: Aug. 8, 2024

(54) AUXILIARY CHARGING SYSTEM AND CONTROL METHOD THEREOF

(71) Applicant: CHI-YUEN CHAU, Taichung City (TW)

(72) Inventor: CHI-YUEN CHAU, Taichung City (TW)

(21) Appl. No.: 18/511,941

(22) Filed: Nov. 16, 2023

Related U.S. Application Data
(60) Provisional application No. 63/426,350, filed on Nov. 17, 2022.

(51) Int. Cl. B60L 53/57; B60K 17/04; B60L 50/60; B60L 53/62; B62D 61/12

(52) U.S. Cl. CPC B60L 53/57; B60K 17/04; B60L 50/60; B60L 53/62; B62D 61/12

(57) ABSTRACT

An auxiliary charging system and a control method thereof are provided in the present invention. The auxiliary charging system is adapted to an electric vehicle and includes a computing core, a driving charging module, a landing gear, and at least one auxiliary wheel. The driving charging module is disposed in a vehicle frame and coupled to the computing core. The landing gear is rotatably disposed in the vehicle frame and controlled by the computing core. The at least one auxiliary wheel is pivotally connected to the landing gear and connected to the driving charging module. The first battery pack of the electric vehicle is coupled to the driving charging module and the computing core, and the second battery pack is coupled to the driving charging module and the computing core. When the computing core detects that a battery charge level of the first battery pack or the second battery pack is lower than a default value, the computing core controls the landing gear to descend, so that the at least one auxiliary wheel contacts and rotates along the ground to activate the driving charging module and to transmit electric current to the first battery pack or the second battery pack.

### CROSS-REFERENCE TO RELATED APPLICATION

This application claims the priority benefit of U.S. provisional application Ser. No. 63/426,350, filed on Nov. 17, 2022. The entirety of the above-mentioned patent application is hereby incorporated by reference herein and made a part of this specification.

### TECHNICAL FIELD

The present invention relates to a charging system, in particular, relates to an auxiliary charging system adapted to an electric vehicle and a control method thereof.

### DESCRIPTION OF THE BACKGROUND ART

As awareness of environmental protection in the international society increases, the usage of fossil energy that has been utilized extensively in the past will gradually be restricted. The reason is that fossil energy such as oil, coal, and natural gas will produce toxic waste gas during the combustion process, causing air pollution and carbon dioxide gas, which results in global climate warming. Hence, various countries in the world have developed a great amount of clean energy sources such as nuclear energy and renewable energy to replace fossil energy.

Among sources of pollution, fuel vehicles are also one of the main sources of exhaust gas and greenhouse gas emissions. Hence, electric vehicles have been widely developed. The existing charging methods of electric vehicles can be roughly divided into two categories: battery swap stations and charging piles. Battery swapping stations are mainly utilized in electric scooters. The main reason is that the batteries of electric scooters have lighter weight. The electric scooters can be driven to the battery swapping station, the batteries that have reached the bottom of the battery charge level are removed, and the removed batteries can be installed into the battery swapping station to facilitate recharging. The fully charged batteries can then be removed from the battery swapping station to be loaded into the electric scooters. The charging piles are mostly applied to the electric vehicles. Due to the batteries of electric vehicles are large in dimension and difficult to disassemble, the electric vehicles are driven to the charging pile and connected to the power plug for facilitating electric charging. Whether the battery swapping station or charging piles, in addition to expensive building cost, a great amount of area of land will be also consumed. In addition, the distribution density of battery swapping stations and charging piles in suburban areas is generally insufficient, which easily causes range anxiety after the electric vehicles leave urban areas.

### SUMMARY

The present invention is directed to an auxiliary charging system, which is adapted to electric vehicles. When the stored electricity is lower than the default value, the auxiliary charging system may be automatically activated, and as the electric vehicle travels, it may generate electrical energy for recharging the electric vehicle, and thus the endurance of electric vehicles is increased.

The auxiliary charging system of the present invention is adapted to an electric vehicle having a vehicle frame, a plurality of tires, a first battery pack, and a second battery pack. The auxiliary charging system includes a computing core, a driving charging module, a landing gear, and at least one auxiliary wheel. The driving charging module is disposed in the vehicle frame and coupled to the computing core. The landing gear is rotatably arranged in the vehicle frame and controlled by the computing core. The at least one auxiliary wheel is pivotally connected to the landing gear and connected to the driving charging module. The first battery pack is coupled to the driving charging module and the computing core, and the second battery pack is coupled to the driving charging module and the computing core. When the computing core detects that the battery charge level of the first battery pack or the second battery pack is lower than the default value, the computing core controls the landing gear to descend from a vehicle frame, so that at least one auxiliary wheel contacts and rotates along the ground to activate the driving charging module and to transmit electric current to the first battery pack or the second battery pack.

The control method of the auxiliary charging system of the present invention includes: the computing core detects the battery charge levels of the first battery pack and the second battery pack. When the battery charge level of the first battery pack or the second battery pack is lower than the default value, the computing core controls the landing gear to be descended from the vehicle frame, so that the at least one auxiliary wheel contacts and rotates along the ground. The at least one auxiliary wheel activates the driving charging module and transmits electric current to the first battery pack or the second battery pack. When the battery charge levels of the first battery pack and the second battery pack are higher than the default value, the computing core controls the landing gear to be lifted to the vehicle frame, so that at least one auxiliary wheel is moved away from the ground.

In an embodiment of the present invention, when at least one auxiliary wheel contacts the ground and rotates synchronously during travel of the tires, the computing core switches the driving charging module to neutral mode to bypass the at least one auxiliary wheel.

In an embodiment of the present invention, when at least one auxiliary wheel contacts the ground, the computing core switches the driving charging module to the driving mode to output power to the at least one auxiliary wheel.

In an embodiment of the present invention, when the battery charge level of one of the first battery pack and the second battery pack is lower than a default value, the computing core controls the other one of the first battery pack and the second battery pack to supply electrical energy to the electric vehicle.

Based on the above, the auxiliary charging system of the present invention is adapted for the electric vehicle. During travel of the electric vehicle, the electrical energy stored in the first battery pack and the second battery pack may be converted into kinetic energy to drive multiple tires. When the battery charge level of the first battery pack or the second battery pack is lower than the default value, the auxiliary charging system may activate itself, so that the auxiliary wheels contact and rotate along the ground. The driving charging module is thus activated to transmit electric current to the first battery pack or the second battery pack. Hence, the auxiliary charging system of the present invention can recycle the kinetic power to generate electrical energy and recharge the electric vehicle during travel, thereby increasing the cruising range of the electric vehicle.

Furthermore, the control method of the auxiliary charging system of the present invention, through detecting the battery charge levels of the first battery pack and the second battery pack of the electric vehicle by the computing core in real time, when the battery charge level of the first battery pack or the second battery pack is lower than the default value, the computing core automatically descends the landing gear for switching to the charging mode. Hence, the auxiliary wheels contact the ground and rotate during travel of the electric vehicle for activating the driving charging module, so as to convert the kinetic power generated by the auxiliary wheels to electrical energy for recharging the first battery pack or the second battery pack. When the battery charge levels of both the first and second battery packs are higher than the default value, the computing core automatically lifts the landing gear and keeps the auxiliary wheels away from the ground to disengage the charging mode.

### BRIEF DESCRIPTION OF THE DRAWINGS

The accompanying drawings are included to provide a further understanding of the disclosure and are incorporated in and constitute a part of this specification. The drawings illustrating embodiments of the disclosure, together with the description, are served to explain the principles of the present invention.

FIG. 1 is a block diagram of an auxiliary charging system according to an embodiment of the present invention.

FIG. 2 is a flow chart of the control method of the auxiliary charging system of FIG. 1.

FIG. 3 is a schematic structural diagram of the auxiliary charging system of FIG. 1 combined with an electric vehicle.

FIG. 4 is a schematic structural diagram of another embodiment of the auxiliary charging system of FIG. 1 combined with an electric vehicle.

### DESCRIPTION OF THE EMBODIMENTS

The exemplary embodiments of the present invention are now referred to in detail, and examples of exemplary embodiments are described in the accompanying drawings. Whenever possible, same component numerals are utilized in drawings and descriptions to denote the same or similar portions.

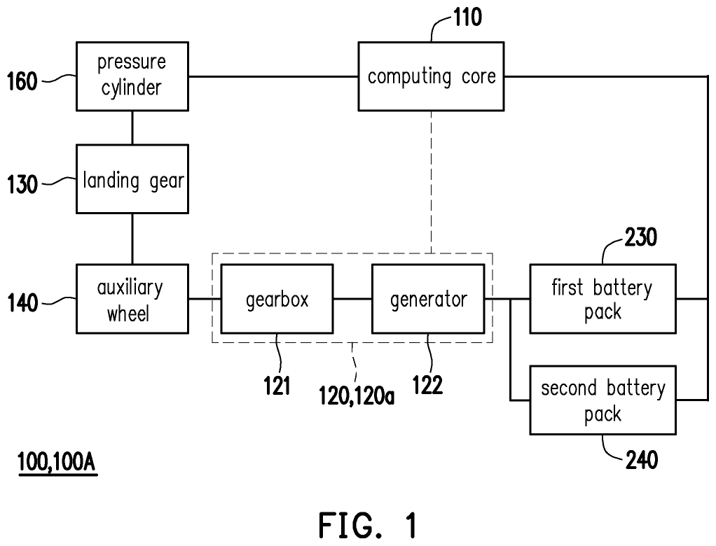

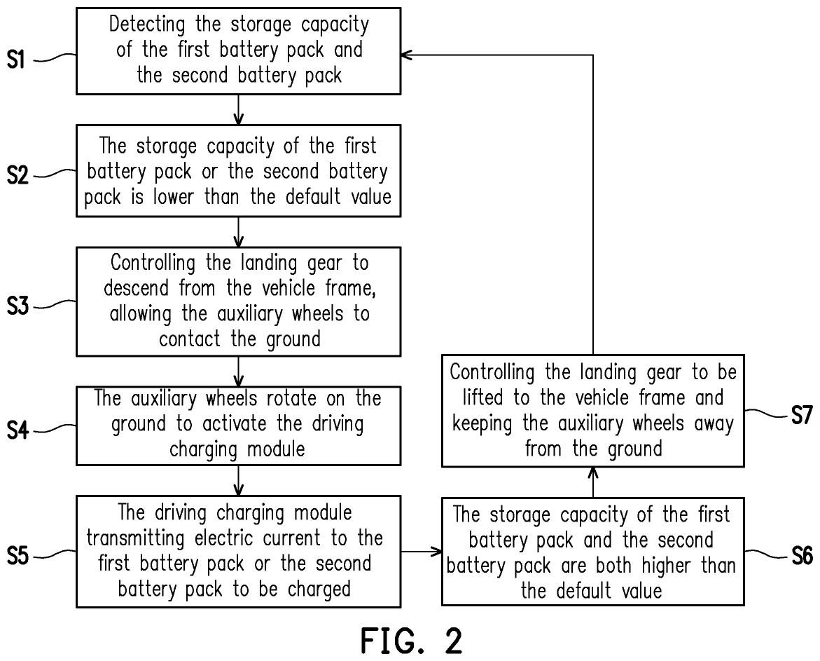

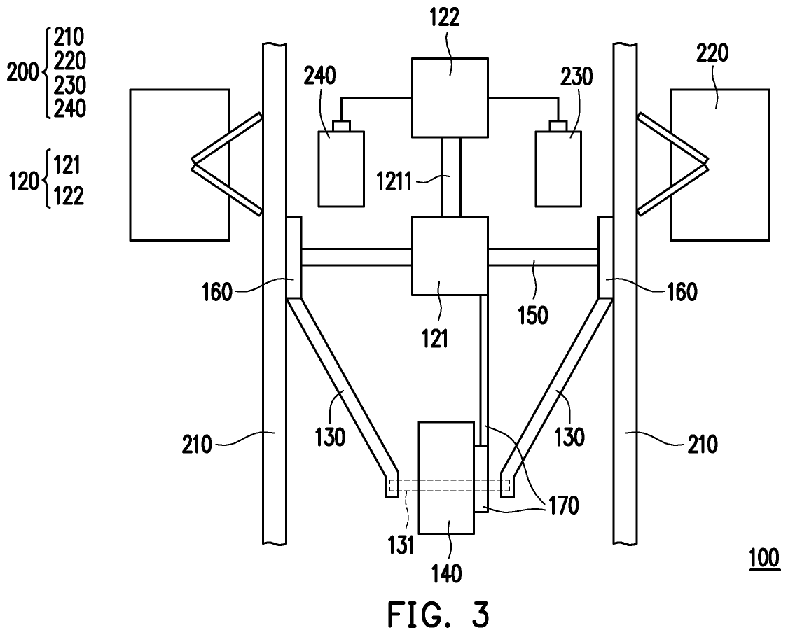

FIG. 1 is a block diagram of an auxiliary charging system according to an embodiment of the present invention. FIG. 2 is a flow chart of the control method of the auxiliary charging system of FIG. 1. FIG. 3 is a schematic structural diagram of the auxiliary charging system of FIG. 1 combined with an electric vehicle.

Referring to FIG. 1 and FIG. 3, the auxiliary charging system 100 of the present invention is adapted to an electric vehicle 200 having a vehicle frame 210, a plurality of tires 220, a first battery pack 230, and a second battery pack 240. In short, the auxiliary charging system 100 can be installed in the vehicle frame 210 of the electric vehicle 200, for example, in the center of the vehicle frame 210, in front of the vehicle frame 210, or behind the vehicle frame 210, depending on the requirements.

For example, on the suspension system, a group of up and down coils are linked to generate electricity, which not only enhance shock absorption effect but also increase the power generation power, and all the four wheels of the vehicle can be installed to increase efficiency.

In other embodiments, the auxiliary charging system 100 can be hung behind the vehicle body by adopting an external hanging mode.

Referring to FIG. 1 to FIG. 3, the auxiliary charging system 100 includes a computing core 110, a driving charging module 120, a landing gear 130, and at least one auxiliary wheel 140.

The computing core 110 is a central processing unit installed in the electric vehicle 200. for receiving various signals from the electric vehicle 200, outputting the corresponding control instructions according to logic, and thus arriving at the purpose of auxiliary charging. The driving charging module 120 is disposed in the vehicle frame 210 and is coupled to the computing core 110. The driving charging module 120 has a charging mode for generating electrical energy, a driving mode for outputting power, and a neutral mode for idling.

The landing gear 130 may be rotatably disposed in the vehicle frame 210 and may be controlled by the computing core 110. That is, the computing core 110 lifts or descends the landing gear 130 according to the circumstances. The at least one auxiliary wheel 140 (shown as a single auxiliary wheel 140 in FIG. 3) is pivotally connected to the landing gear 130 and is connected to the driving charging module 120. Then, the auxiliary wheel 140 and the driving charging module 120 may transmit kinetic power to each other.

Referring to FIG. 3, the first battery pack 230 and the second battery pack 240 of the electric vehicle 200 adopt rechargeable batteries. The first battery pack 230 is coupled to the driving charging module 120 and the computing core 110, and the second battery pack 240 is coupled to driving charging module 120 and the computing core 110.

Referring to FIG. 2 correspondingly, when the computing core 110 detects that the battery charge level of the first battery pack 230 or the second battery pack 240 is lower than the default value, namely the battery charge level is determined to be insufficient, the computing core 110 may control the landing gear 130 to be descended from the vehicle frame. 210, so that the at least one auxiliary wheel 140 contacts and rotates along the ground (e.g., a road). The at least one auxiliary wheel 140 generates power to activate the driving charging module 120 and transmit electric current to the first battery pack 230 or the second battery pack 230, which has an insufficient battery charge level.

In addition, when the at least one auxiliary wheel 140 contacts the ground, the stability of the electric vehicle 200 during travel can also be improved, which is particularly applicable for environments such as slippery roads or muddy ground. The at least one auxiliary wheel 140 is also applicable for uneven roads, which is beneficial in improving the shock absorbing effect of the electric vehicle 200.

Referring to FIG. 1 to FIG. 3, when the computing core 110 detects that the battery charge level of the first battery pack 230 and the second battery pack 240 are both higher than the default value, the battery charge level is determined to be sufficient, and the computing core 110 controls the landing gear 130 to be lifted to the vehicle frame 210, so that the at least one auxiliary wheel 140 is moved away from the ground. Hence, the electric vehicle is allowed to travel at full speed, so as to prevent performance of the electric vehicle being affected by the friction force generated by the at least one auxiliary wheel 140 from contacting the ground.

In other embodiments, the number of the at least one auxiliary wheel 140 may be plural, and the plural auxiliary wheels 140 may be installed on the front or rear side of the vehicle frame 210.

In other embodiments, the electrical energy generated by driving charging module 120 may be also directly supplied to the electric vehicle and may not be limited to recharging the electrical energy to the first battery pack 230 or the second battery pack 240.

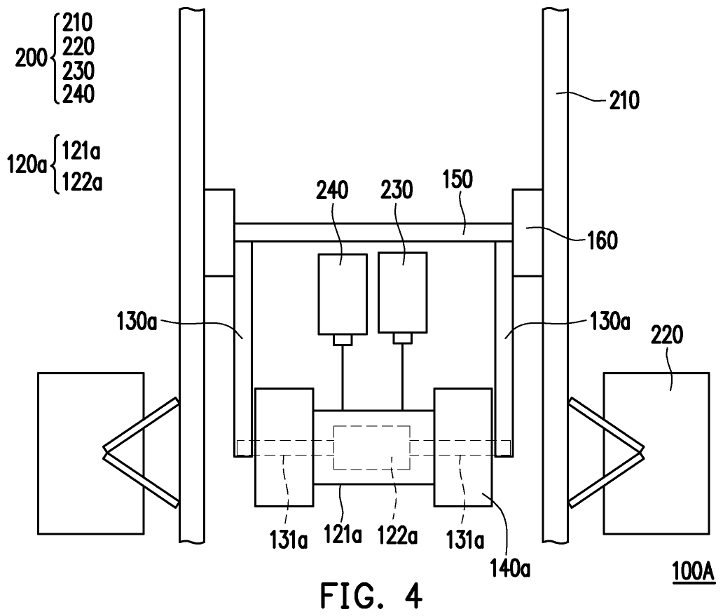

Referring to FIG. 3 and FIG. 4, the auxiliary charging system 100 includes a central shaft 150 and a pressure cylinder 160. The central shaft 150 is disposed in the vehicle frame 210 and is placed laterally. The pressure cylinder 160 is arranged on the central shaft 150 and connected to the landing gear 130. The pressure cylinder 160 is suitable for driving the landing gear 130 to pivot in relative to the central shaft 150 for being lifted to the vehicle frame 210 or descended therefrom. Furthermore, the pressure cylinder 160 is controlled by the computing core 110 and is adapted be operated through electronic, pneumatic, hydraulic, or mechanical fashions.

Referring to FIG. 1 and FIG. 3, the driving charging module 120 of the present embodiment has a gearbox 121 and a generator 122. The gearbox 121 is fixed at the center of the central shaft 150, and the generator 122 is connected to the rotating shaft 1211 of the gearbox 121. The first battery pack 230 and the second battery pack 240 are respectively located on both sides of the generator 122 and respectively coupled thereto. The landing gear 130 has a spindle 131. The spindle 131 is aligned with the center of the central shaft 150. The at least one auxiliary wheel 140 is rotatably sleeved on the spindle 131. It shows that the at least one auxiliary wheel 140 pivots in relative to the spindle 131.

The auxiliary charging system 100 includes a power transmission structure 170, which is rotatably sleeved on the spindle 131 and connected to at least one auxiliary wheel 140 and the gearbox 121.

Referring to FIG. 1 to FIG. 3, in the charging mode of the driving charging module 120, the auxiliary wheels 140 transmit kinetic energy to the gearbox 121 through the power transmission structure 170 (belt or chain) during rotation to achieve deceleration effect. The gearbox 121 then activates the generator 122 through the rotating shaft 1211 to generate electrical energy. In the meantime, the computing core 110 charges the electrical energy into the first battery pack 230 or the second battery pack 240, having a lower battery charge level, until the battery charge levels of both of the battery packs is higher than the default value.

When the battery charge level of the first battery pack 230 or the second battery pack 240 is lower than the default value, the computing core 110 may disconnect the battery pack having low battery charge level, and the battery pack having high battery charge level supplies the required electrical energy for the operation of the electric vehicle 200.

Referring to FIG. 1 and FIG. 3, in the driving mode of the driving charging module 120, the computing core 110 supplies the electrical energy of the first battery pack 230 or the second battery pack 240 to the generator 122, so as to switch the generator 122 to the driving mode and to output kinetic power to the rotating shaft 1211 of gearbox 121. Then, the at least one auxiliary wheel 140 is driven by the power transmission structure 170 to pivot along the spindle 131, which serves as auxiliary power of the electric vehicle 200 when climbing a slope.

FIG. 4 is a schematic structural diagram of another embodiment of the auxiliary charging system of FIG. 1 combined with an electric vehicle.

Referring to FIG. 1 and FIG. 4, the difference between the auxiliary charging system 100A of another embodiment of the present invention and the auxiliary charging system 100 shown in FIG. 3 is that the driving charging module 120a has a generator 121a and a gearbox 122a. The generator 121a is away from the central shaft 150, and the gearbox 122a is disposed in the generator 121a, and the first battery pack 230 and the second battery pack 240 are located within the range of the landing gear 130a and are coupled to the generator 121a.

The landing gear 130a has two spindles 131a, and the at least one auxiliary wheel 140a includes two auxiliary wheels 140a. The two spindles 131a may be rotatably sleeved in the generator 121a and the connect gearbox 122a, and two auxiliary wheels 140a are respectively fixed and sleeved in the two spindles 131a, which shows that the two auxiliary wheels 140a respectively drive the two spindles 131a to rotate simultaneously.

Referring to FIG. 1 to FIG. 3, in the charging mode of the driving charging module 120a, the two auxiliary wheels 140a may transmit kinetic energy to the gearbox 121a through the two spindles 131a during the period of rotation for achieving deceleration effect. The gearbox 121a then activates the generator 122a to generate electrical energy, while the computing core 110 charges the electrical energy into the first battery pack 230 or the second battery pack 240, having low battery charge level, until the battery charge levels of both of the battery packs are higher than the default value.

When the battery charge level of the first battery pack 230 or the second battery pack 240 is lower than the default value, the computing core 110 may disconnect the battery pack having low battery charge level and utilize the battery pack having high battery charge level to supply the required electrical for the operation of the electric vehicle 200.

Referring to FIG. 1 and FIG. 3, in the driving mode of driving charging module 120a, the computing core 110 supplies the electrical energy of the first battery pack 230 or the second battery pack 240 to the generator 122a, so that it switches to the driving mode and outputs power to The gearbox 121a drives the two auxiliary wheels 140a to pivot relative to the landing gear 130a through the two spindles 131a respectively, thereby serving as auxiliary power of the electric vehicle 200 when climbing a slope.

Referring to FIG. 1 and FIG. 2, the control and switching process of the auxiliary charging system 100 is described in detail below.

Step S1: After the auxiliary charging system 100 is activated, the computing core 110 may detect the battery charge levels of the first battery pack 230 and the second battery pack 240. Step S2: When the computing core 110 detects that the battery charge level of the first battery pack 230 or the second battery pack 240 is lower than the default value. Step S3: The computing core 110 controls the landing gear 130 to descend from the vehicle frame 210. Step S4: the auxiliary wheels 140 are driven to contact and rotate along the ground, and the kinetic power of the rotation of the auxiliary wheels 140 is utilized to activate the driving charging module 120. Step S5: The driving charging module 120 transmits electric current to the first battery pack 230 or the second battery pack 240 to be charged. After charging for a period of time, step S6: when the computing core 110 detects that the battery charge levels of the first battery pack 230 and the second battery pack 240 are both higher than the default value. Step S7: The computing core 110 controls the landing gear 130 to be lifted to the vehicle frame 210, so that the auxiliary wheels 140 are moved away from the ground.

Referring to FIG. 1 and FIG. 3, when the auxiliary wheels 140 contact the ground and rotate synchronously with the movement of the plurality of tires 220 of the electric vehicle 200, the computing core 110 switches the driving charging module 120 to the neutral mode to bypass the auxiliary wheels 140. It shows that the auxiliary wheels 140 are idling during the period of rotation, so that the auxiliary wheels 140 cannot drive the gearbox 121 and the generator 122.

Referring to FIG. 1 and FIG. 3, when the auxiliary wheels 140 contact the ground, the computing core 110 switches the driving charging module 120 to the driving mode to output kinetic power to the auxiliary wheels 140, which may enhance the performance of the electric vehicle 200 in a short period, so that the slippery during climbing a slope or traveling in the rain may be prevented.

Referring to FIG. 1 and FIG. 3, when the battery charge level of one of the first battery pack 230 and the second battery pack 240 is lower than the default value, the computing core 110 controls the first battery pack 230 and the second battery pack 240. The other one of the first battery pack 230 and the second battery pack 240 supplies electrical energy to the electric vehicle 200.

It is noted herein that the first battery pack 230 and the second battery pack 240 are connected in parallel. When one of the battery packs is supplying power, the other one of the battery packs is charged until the battery charge levels of the first battery pack 230 and the second battery pack 240 are both higher than the default value, and then the charging mode may be disengaged.

In sum, the auxiliary charging system of the present invention is suitable for an electric vehicle. During travel of the electric vehicle, the auxiliary charging system may convert the electrical energy stored in the first battery pack and the second battery pack into kinetic energy to drive multiple tires. When the battery charge level of the first battery pack or the second battery pack is lower than the default value, the auxiliary charging system may activate itself, so that the auxiliary wheels contact and rotate along the ground for activating the driving charging module and transmitting electric current to the first battery pack or the second battery pack. Hence, the auxiliary charging system of the present invention may recycle kinetic power to generate electrical energy for recharging the electric vehicle during travel, thereby improving the cruising range of the electric vehicle.

Furthermore, the control method of the auxiliary charging system of the present invention, through detecting the battery charge levels of the first battery pack and the second battery pack of the electric vehicle by the computing core in real time, when the battery charge level of the first battery pack or the second battery pack is lower than the default value, the computing core automatically descends the landing gear for switching to the charging mode. Hence, the auxiliary wheels contact the ground and rotate during travel of the electric vehicle for activating the driving charging module, so as to convert the kinetic power generated by the auxiliary wheels to electrical energy for recharging the first battery pack or the second battery pack. When the battery charge levels of both the first and second battery packs are higher than the default value, the computing core automatically lifts the landing gear and keeps the auxiliary wheels away from the ground to disengage the charging mode.

What is claimed is:

1. An auxiliary charging system, adapted to an electric vehicle having a vehicle frame, a plurality of tires, a first battery pack, and a second battery pack, comprising:
a computing core;
a driving charging module, disposed in the vehicle frame and coupled to the computing core;
a landing gear, rotatably disposed in the vehicle frame and controlled by the computing core; and
at least one auxiliary wheel, pivotally connected to the landing gear and connected to the driving charging module,
wherein the first battery pack is coupled to the driving charging module and the computing core, and the second battery pack is coupled to the driving charging module and the computing core,
wherein when the computing core detects that a battery charge level of the first battery pack or the second battery pack is lower than a default value, the computing core controls the landing gear to descend from the vehicle frame, so that the at least one auxiliary wheel contacts and rotates along the ground to activate the driving charging module and transmit electrical current to the first battery pack or the second battery pack.

2. The auxiliary charging system according to claim 1, wherein when the computing core detects that the battery charge levels of the first battery pack and the second battery pack are both higher than a default value, the computing core controls the landing gear to be lifted to the vehicle frame, so that the at least one auxiliary wheel is away from the ground.

3. The auxiliary charging system according to claim 1, further comprising a central shaft and a pressure cylinder, wherein the central shaft is disposed in the vehicle frame, the pressure cylinder is disposed in the central shaft and connected to the landing gear, and the pressure cylinder is controlled by the computing core.

4. The auxiliary charging system according to claim 3, wherein the driving charging module has a gearbox and a generator, the gearbox is fixedly disposed in the central shaft, the generator is connected to a rotating shaft of the gearbox, and the first battery pack and the second battery pack are respectively located on both sides of the generator and respectively coupled to the generator.

5. The auxiliary charging system according to claim 4, wherein the landing gear has a spindle, the spindle is aligned with a center of the central shaft, and the at least one auxiliary wheel is rotatably sleeved on the spindle.

6. The auxiliary charging system according to claim 5, further comprising a power transmission structure rotatably sleeved on the spindle and connecting the at least one auxiliary wheel and the gearbox.

7. The auxiliary charging system according to claim 6, wherein the generator is adapted to be switched to a driving mode and outputs power to the rotating shaft and the gearbox for driving the at least one auxiliary wheel pivoting along the spindle through the power transmission structure.

8. The auxiliary charging system according to claim 3, wherein the driving charging module has a generator and a gearbox, the generator is disposed away from the central shaft, and the gearbox is disposed in the generator, and the first battery pack and the second battery pack are located within a range of the landing gear and coupled to the generator.

9. The auxiliary charging system according to claim 7, wherein the landing gear has two spindles, and the at least one auxiliary wheel comprises two auxiliary wheels, and the two spindles are rotatably sleeved and installed in the the generator and connected to the gearbox, and the two auxiliary wheels are respectively sleeved and fixed on the two spindles.

10. The auxiliary charging system according to claim 9, wherein the generator is adapted to be switched to a driving mode and outputs power to the gearbox for driving the two spindles and the two auxiliary wheels to pivot in relative to the landing gear.

11. A control method of an auxiliary charging system, adapted to a electric vehicle having a vehicle frame, a plurality of tires, a first battery pack, and a second battery pack, wherein the control method includes:
a computing core;
a driving charging module, disposed in the vehicle frame and coupled to the computing core;
a landing gear, rotatably disposed in the vehicle frame and coupled to the computing core; and
at least one auxiliary wheel, pivotally connected to the landing gear and connected to the driving charging module;
wherein the first battery pack is coupled to the driving charging module and the computing core, the second battery pack is coupled to the driving charging module and the computing core, and the control method of the auxiliary charging system comprises:
the computing core detects battery charge levels of the first battery pack and the second battery pack,
when the battery charge level of the first battery pack or the second battery pack is lower than a default value, the computing core controls the landing gear to descend from the vehicle frame, so that the at least one auxiliary wheel contacts and rotates along the ground,
the at least one auxiliary wheel activates the driving charging module and transmits electric current to the first battery pack or the second battery pack,
when the battery charge levels of the first battery pack and the second battery pack are both higher than the default value,
the computing core controls the landing gear to be lifted to the vehicle frame, so that the at least one auxiliary wheel is moved away from the ground.

12. The control method of the auxiliary charging system according to claim 11, wherein when the at least one auxiliary wheel contacts the ground, and the plurality of tires travel and rotate synchronously, the computing core switches the driving charging module to a neutral mode to bypass the at least one auxiliary wheel.

13. The control method of the auxiliary charging system according to claim 11, wherein when the at least one auxiliary wheel contacts the ground, the computing core switches the driving charging module to the driving mode to output power to the at least one auxiliary wheel.

14. The control method of the auxiliary charging system according to claim 11, wherein when the battery charge level of one of the first battery pack and the second battery pack is lower than the default value, the computing core controls the other one of the first battery pack and the second battery pack to supply electrical energy to the electric vehicle.
